(19) United States
(12) Patent Application Publication
(10) Pub. No.: US 2025/0297120 A1
(43) Pub. Date: Sep. 25, 2025

(54) CONDUCTIVE INK COMPOSITIONS COMPRISING GOLD COMPLEXES

(71) Applicant: ELECTRONINKS INCORPORATED, Austin, TX (US)

(72) Inventors: S. Brett WALKER, Austin, TX (US); Ayan MAITY, Austin, TX (US)

(73) Assignee: ELECTRONINKS INCORPORATED, Austin, TX (US)

(21) Appl. No.: 18/863,554

(22) PCT Filed: May 5, 2023
(86) PCT No.: PCT/US2023/066637

§ 371 Date: Nov. 6, 2024

Related U.S. Application Data
(60) Provisional application No. 63/339,313, filed on May 6, 2022.

(51) Int. Cl. C09D 11/52; C09D 11/033; C09D 11/037; C09D 11/322; C09D 11/36

(52) U.S. Cl. CPC C09D 11/52; C09D 11/033; C09D 11/037; C09D 11/322; C09D 11/36

(57) ABSTRACT

Conductive ink compositions comprising gold complexes are provided. Also provided are methods of preparing the conductive ink compositions, methods of forming conductive structures from the conductive ink compositions, and structures formed from the conductive ink compositions. The conductive ink compositions preferably comprise a gold metal, an alkylamine ligand, and a solvent. The conductive ink compositions can be used to form conductive structures comprising gold, for example by inkjet or other printing methods, at temperatures of 300° C. or less. Such conductive structures can be formed on a variety of substrates.

### CROSS-REFERENCE TO RELATED APPLICATIONS

This application claims the benefit of U.S. Provisional Application No. 63/339,313, filed on May 6, 2022, the disclosure of which is incorporated herein by reference in its entirety.

### FIELD OF THE INVENTION

The present disclosure relates generally to novel ink compositions comprising gold and their methods of preparation and use. More particularly, the present disclosure relates to particle-free conductive ink compositions comprising gold complexes, including inks prepared using novel gold organometallic complexes. The inks are particularly useful in inkjet printing, including aerosol jet machine printing applications.

### BACKGROUND OF THE INVENTION

The electronics, display, and energy industries rely on the production and use of coatings and patterns of conductive materials to form circuits on organic and inorganic substrates. Printed electronics offer an attractive alternative to conventional technologies by enabling the creation of large-area, flexible devices at low cost. There is a great need for high-conductivity materials with fine-scale features in modern electronics such as solar cell electrodes, flexible displays, radio frequency identification tags, antennas, and many more. In efforts to make these high-technology devices increasingly affordable, the substrates used typically have relatively little temperature resilience and require low processing temperatures to maintain integrity.

The vast majority of commercially produced conductive inks are specifically designed for inkjet, screen-printing, or roll-to-roll processing methods in order to process large areas with fine-scale features in short time periods. These inks have disparate viscosities and synthesis parameters. Particle-based inks are based on conductive metal particles, which are typically synthesized separately and then incorporated into an ink formulation. The resulting ink is then tuned for specific particle process.

Typically, precursor-based inks are based on thermally unstable precursor complexes that undergo reduction to a conductive metal upon heating. Prior particle- and precursor-based methods generally rely on high temperatures to form conductive coatings and thus may not be compatible with substrates that require low processing temperatures to maintain integrity. For example, particle- and precursor-based conductive ink compositions are available that decompose at temperatures near 150° C., yielding electrical conductivities approaching that of bulk metal. Unfortunately, even these temperatures render the ink incompatible with many plastic and paper substrates commonly used in flexible electronic and biomedical devices.

Metallo-organic precursor materials have begun to gain attention for the preparation of particle free conductive ink formulations. Chemical compounds with a metal atom and one or more organic ligands connected to the metal atom through a heteroatom such as oxygen or nitrogen are typically known as metallo-organic compounds. For comparison, chemical compounds having a direct attachment between a metal atom and a carbon atom are typically referred to as organometallic compounds. As a result of the strong metal-carbon bonds in organometallic compounds, they are commonly considered less suitable for low temperature printing applications. In contrast, metallo-organic compounds are typically considered easier to decompose, as the metal-heteroatom bonds are often weaker.

Printable ink compositions comprising gold have previously been described for printing conductive features. Most of the known gold-based ink rely on nanoparticle-based formulations, however. Accordingly, there remains a need for conductive ink compositions comprising gold that display improved properties. It is thus an object of the present invention to provide particle-free conductive gold ink compositions and methods for their preparation and use, in particular compositions that can form conductive structures at low temperatures.

### SUMMARY OF THE INVENTION

The instant disclosure addresses these and other considerations by providing in one aspect a particle-free conductive ink composition comprising a gold metal, an alkylamine ligand, and a solvent, wherein the particle-free conductive ink composition forms a conductive metallic film structure by curing at an elevated temperature.

In some aspects, the techniques described herein relate to a particle-free conductive ink composition, wherein the gold metal is a gold(I) metal ion.

In some aspects, the techniques described herein relate to a particle-free conductive ink composition, wherein the alkylamine ligand is volatile at a temperature of no more than about 200° C.

In some aspects, the techniques described herein relate to a particle-free conductive ink composition, wherein the alkylamine ligand is a C₃-C₁₂ alkylamine ligand.

In some aspects, the techniques described herein relate to a particle-free conductive ink composition, wherein the alkylamine ligand is a branched alkylamine ligand.

In some aspects, the techniques described herein relate to a particle-free conductive ink composition, wherein the alkylamine ligand is a primary alkylamine ligand.

In some aspects, the techniques described herein relate to a particle-free conductive ink composition, wherein the alkylamine ligand is an alkyl-substituted hexylamine. More specifically, the alkyl-substituted hexylamine is a methyl- or ethyl-substituted hexylamine, or even is 2-ethyl-1-hexylamine or 2-amino-5-methylhexane.

In some aspects, the techniques described herein relate to a particle-free conductive ink composition, wherein the alkylamine ligand is a di-chelated primary, secondary, or tertiary alkyl diamine compound.

In some aspects, the techniques described herein relate to a particle-free conductive ink composition, wherein the alkylamine ligand has a specific structure.

In some aspects, the techniques described herein relate to a particle-free conductive ink composition, wherein the alkylamine ligand is a C₂-C₁₂ alkylamine ligand substituted with at least one heteroatom.

In some aspects, the techniques described herein relate to a particle-free conductive ink composition, wherein the at least one heteroatom is at least one oxygen or sulfur.

In some aspects, the techniques described herein relate to a particle-free conductive ink composition, wherein the alkylamine ligand is a C₄-C₁₀ 2-amino-alkyl compound.

In some aspects, the techniques described herein relate to a particle-free conductive ink composition, wherein the solvent includes an aromatic solvent.

In some aspects, the techniques described herein relate to a particle-free conductive ink composition, wherein the solvent includes an alkyl or aromatic ether solvent.

In some aspects, the techniques described herein relate to a particle-free conductive ink composition, wherein the solvent includes tetrahydrofuran or 2-methyl tetrahydrofuran.

In some aspects, the techniques described herein relate to a particle-free conductive ink composition, wherein the solvent includes an amide-type solvent.

In some aspects, the techniques described herein relate to a particle-free conductive ink composition, wherein the solvent includes an aromatic heterocyclic solvent. More specifically, the aromatic heterocyclic solvent can include a pyridine or a pyrazine, or can even include pyridine or 2,5-dimethylpyrazine.

In some aspects, the techniques described herein relate to a particle-free conductive ink composition, further including a counterion.

In some aspects, the techniques described herein relate to a particle-free conductive ink composition, wherein the counterion is a carboxylate.

In some aspects, the techniques described herein relate to a particle-free conductive ink composition, wherein the particle-free conductive ink composition releases carbon dioxide upon heating.

In some aspects, the techniques described herein relate to a particle-free conductive ink composition, wherein the particle-free conductive ink composition releases carbon dioxide upon heating at no more than about 300° C.

In some aspects, the techniques described herein relate to a particle-free conductive ink composition, wherein the counterion is a haloacetate.

In some aspects, the techniques described herein relate to a particle-free conductive ink composition, wherein the haloacetate is trifluoroacetate.

In some aspects, the techniques described herein relate to a particle-free conductive ink composition, wherein the counterion is nitrate, nitrite, tetrafluroborate, or hexafluorophosphate.

In some aspects, the techniques described herein relate to a particle-free conductive ink composition, wherein the particle-free conductive ink composition forms a conductive metallic film by curing at no more than 300° C.

In some aspects, the techniques described herein relate to a particle-free conductive ink composition, wherein the conductive metallic film displays a conductivity of at least 1% bulk metal conductivity.

In some aspects, the techniques described herein relate to methods for applying particle-free conductive ink compositions to a substrate; and curing the composition at an elevated temperature to form the conductive film.

In some aspects, the techniques described herein relate to a method, wherein the applying step includes a printing step.

In some aspects, the techniques described herein relate to a method, wherein the printing step is a jet printing step.

In some aspects, the techniques described herein relate to a method, wherein the jet printing step is an aerosol jet printing step.

In some aspects, the techniques described herein relate to a method, wherein the composition is cured at no more than 300° C.

In some aspects, the techniques described herein relate to a conductive film formed by applying the particle-free conductive ink composition to a substrate and curing the composition at an elevated temperature to form the conductive film.

In some aspects, the techniques described herein relate to a conductive film, wherein the curing is at no more than 300° C.

In some aspects, the techniques described herein relate to a method of preparing a particle-free conductive ink composition including the steps of: providing an alkylamine-gold complex; and dissolving the alkylamine-gold complex in a solvent to form the particle-free conductive ink composition; wherein the alkylamine-gold complex includes a gold metal and an alkylamine ligand; and wherein the particle-free conductive ink composition forms a conductive metallic film by curing at an elevated temperature.

In some aspects, the techniques described herein relate to a method, wherein the gold metal is a gold(I) metal ion.

In some aspects, the techniques described herein relate to a method, wherein the alkylamine ligand is volatile at a temperature of no more than about 200° C.

In some aspects, the techniques described herein relate to a method, wherein the alkylamine ligand is a C₃-C₁₂ alkylamine.

In some aspects, the techniques described herein relate to a method, wherein the alkylamine ligand is a branched alkylamine.

In some aspects, the techniques described herein relate to a method, wherein the alkylamine ligand is a primary alkylamine.

In some aspects, the techniques described herein relate to a method, wherein the alkylamine ligand is an alkyl-substituted hexylamine. More specifically, the alkyl-substituted hexylamine is a methyl- or ethyl-substituted hexylamine, or even is 2-ethyl-1-hexylamine or 2-amino-5-methylhexane.

In some aspects, the techniques described herein relate to a method, wherein the alkylamine ligand is a di-chelated primary, secondary, or tertiary alkyl diamine compound.

In some aspects, the techniques described herein relate to a method, wherein the alkylamine ligand has a specific structure.

In some aspects, the techniques described herein relate to a method, wherein the alkylamine ligand is a C₂-C₁₂ alkylamine ligand substituted with at least one heteroatom.

In some aspects, the techniques described herein relate to a method, wherein the at least one heteroatom is at least one oxygen or sulfur.

In some aspects, the techniques described herein relate to a method, wherein the alkylamine ligand is a C₄-C₁₀ 2-amino-alkyl compound.

In some aspects, the techniques described herein relate to a method, wherein the solvent includes an aromatic solvent.

In some aspects, the techniques described herein relate to a method, wherein the solvent includes an alkyl or aromatic ether solvent.

In some aspects, the techniques described herein relate to a method, wherein the solvent includes tetrahydrofuran or 2-methyl tetrahydrofuran.

In some aspects, the techniques described herein relate to a method, wherein the solvent includes an amide-type solvent.

In some aspects, the techniques described herein relate to a method, wherein the solvent includes an aromatic heterocyclic solvent. More specifically, the aromatic heterocyclic solvent can include a pyridine or a pyrazine, or even can include pyridine or 2,5-dimethylpyrazine.

In some aspects, the techniques described herein relate to a method, wherein the particle-free conductive ink composition further includes a counterion.

In some aspects, the techniques described herein relate to a method, wherein the counterion is a carboxylate.

In some aspects, the techniques described herein relate to a method, wherein the particle-free conductive ink composition releases carbon dioxide upon heating.

In some aspects, the techniques described herein relate to a method, wherein the particle-free conductive ink composition releases carbon dioxide upon heating at no more than about 300° C.

In some aspects, the techniques described herein relate to a method, wherein the counterion is a haloacetate.

In some aspects, the techniques described herein relate to a method, wherein the haloacetate is trifluoroacetate.

In some aspects, the techniques described herein relate to a method, wherein the counterion is nitrate, nitrite, tetrafluroborate, or hexafluorophosphate.

### BRIEF DESCRIPTION OF THE DRAWINGS

FIG. 1 shows an image of an ink formulation prepared according to the disclosure.

FIG. 2 shows the results of printing an ink formulation of the disclosure on a glass substrate.

FIG. 3 shows the results of printing an ink formulation of the disclosure on a circuit board substrate.

FIG. 4 shows a circuit board used to measure the resistance of a gold film printed using an ink formulation of the disclosure.

### DETAILED DESCRIPTION OF THE INVENTION

### Conductive Gold Ink Compositions

Particle-free inks comprising metallo-organic compounds have several benefits over nanoparticle-based inks. Most importantly, particle-free inks comprising metallo-organic compounds decompose more cleanly and often at lower temperature than inks comprising nanoparticles. For example, multi-hour printing with fine features can be attained with particle-free inks comprising metallo-organic compounds. Metallo-organic inks also have higher shelf life when compared to nanoparticle-based inks. Disclosed herein are gold(I) amine-based ink formulations, and methods for their synthesis and use, that have been used to produce dry printing highly conductive fine lines by aerosol jet printing technology.

Accordingly, the instant disclosure provides in one aspect particle-free conductive ink compositions comprising a gold metal, an alkylamine ligand, and a solvent, wherein the particle-free conductive ink composition forms a conductive metallic film structure by curing at an elevated temperature.

By elevated temperature is meant a temperature above room temperature. In some embodiments, the particle-free conductive ink compositions of the instant disclosure form a conductive metallic film structure by curing at no more than about 400° C., at no more than about 300° C., at no more than about 200° C., or even at no more than about 100° C.

The alkylamine ligand of the instant conductive ink compositions is in some embodiments a C₃-C₁₂ alkylamine ligand. In more specific embodiments, the alkylamine ligand is a C₄-C₁₀ alkylamine ligand, a C₅-C₈alkylamine ligand, or even a C₈ alkylamine ligand. In some embodiments, the alkylamine ligand is a branched-chain alkylamine ligand. In some embodiments, the alkylamine ligand is a primary alkylamine ligand. In some embodiments, the alkylamine ligand is a primary C₃-C₁₂ alkylamine ligand, a primary C₅-C₁₀ alkylamine ligand, or more specifically a primary C₈ alkylamine ligand. In some embodiments, the particle-free conductive ink compositions comprise more than one alkylamine ligand.

In some embodiments, the alkylamine ligand is an alkyl-substituted hexylamine. In more specific embodiments, the alkyl-substituted hexylamine is a methyl- or ethyl-substituted hexylamine. Even more specifically, the alkyl-substituted hexylamine is 2-ethyl-1-hexylamine or 2-amino-5-methylhexane.

The alkylamine ligand of the instant conductive ink compositions is preferably volatile at a temperature of no more than about 400° C., at no more than about 300° C., at no more than about 200° C., or even at no more than about 100° C.

In some embodiments, the conductive ink compositions comprise a specially designed gold(I) amine complex that provides a particularly stable precursor for particle-free conductive ink formulations. Gold (I) amine complexes comprising the above-described alkylamine ligands can be synthesized, for example, as shown in the following reaction scheme:

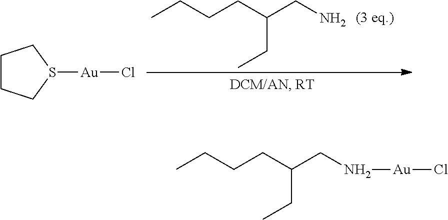

In some embodiments, the alkylamine ligand can be 2-amino-5-methylhexane. Inks comprising gold complexes with this ligand can be prepared, for example, from 2-amino-5-methylhexane gold chloride:

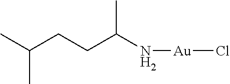

Specifically, such inks can be prepared by dissolving this precursor in a suitable solvent, for example an aromatic heterocyclic solvent, such as pyridine or 2,5-dimethylpyrazine. The solid content of such an ink can be, for example, about 4%. The inks can be cured for short time periods at low temperatures, for example, for 15 minutes at 160° C. or for 16 hours at 100° C.

In some embodiments, the alkylamine in the particle-free conductive ink compositions is a di-chelated primary, secondary, or tertiary C₃-C₁₄ alkyl diamine compound. A stable diamine gold(I) precursor ink composition comprising such compounds can, for example, be prepared as described in the following scheme:

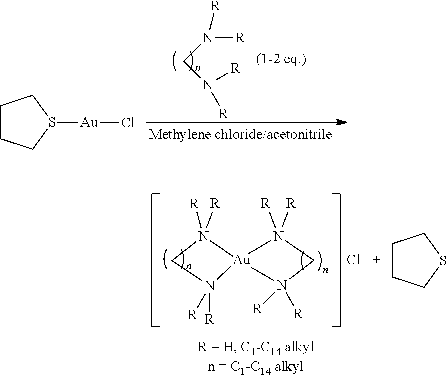

In these complexes, the alkylamine ligand has a structure of formula (I):

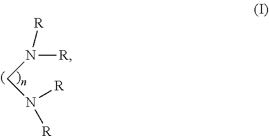

wherein each R group is independently H or a C₁-C₁₄ alkyl group, and each n is independently from 1 to 14 (i.e., the linker comprises from 1-14 methylene groups). In more specific embodiments, each R group is independently H or a C₁-C₄ alkyl group, and each n is independently from 1 to 10, from 1 to 8, or even from 1 to 6. In other more specific embodiments, n is from 2 to 14, from 4 to 14, from 6 to 14, or even from 8 to 14. In still other more specific embodiments, n is from 2 to 12, from 4 to 10, or even from 6 to 8.

In some embodiments, the alkylamine ligand of the particle-free ink compositions is a C₂-C₁₂ alkylamine ligand, wherein the alkyl chain is substituted with at least one heteroatom. More specifically, the alkyl chain can be substituted with at least one oxygen or sulfur. Even more specifically, the alkyl chain can be substituted with at least one oxygen. In some embodiments, the alkylamine ligand is a C₃-C₁₂ alkylamine ligand, a C₄-C₁₀ alkylamine ligand, a C₅-C₈ alkylamine ligand, or even a C₈ alkylamine, wherein the alkyl chain is substituted with at least one heteroatom, in particular, at least one oxygen or sulfur, or at least one oxygen.

The preparation of an exemplary gold(I) amine complex comprising an oxygen-substituted alkyl amine suitable for use in the particle-free ink compositions of the instant disclosure is shown in the following scheme:

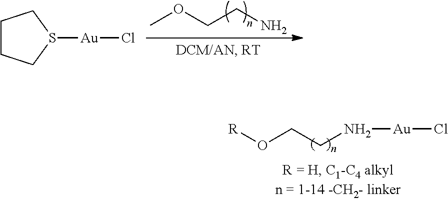

In these complexes, the R group is H or a C₁-C₄ alkyl group, and n is from 1 to 14 (i.e., the link comprises from 1-14 methylene groups). In more specific embodiments, n is from 1 to 10, from 1 to 8, or even from 1 to 6. In other more specific embodiments, n is from 2 to 14, from 4 to 14, from 6 to 14, or even from 8 to 14. In still other more specific embodiments, n is from 2 to 12, from 4 to 10, or even from 6 to 8.

In some embodiments, the alkylamine ligand in the particle-free conductive ink compositions can be 2-amino-5-methylhexane, 2-amino-6-methylheptane, or another similar 2-amino-alkyl compound comprising from 4 to 10 carbons. The details of preparing an exemplary complex of this type is described below:

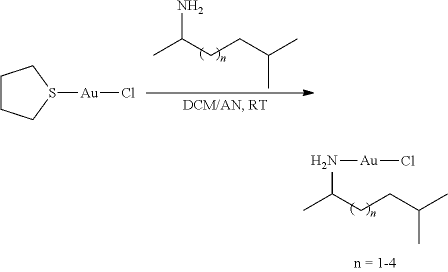

In some embodiments, the particle-free conductive ink compositions can comprise a counterion comprising a carboxylate. In these compositions, decarboxylation of the counterion can generate conductive gold metal, carbon dioxide, a decarboxylated carbon residue, and an uncoordinated amine. In some embodiments, the carboxylate can be a haloacetate, for example a fluoroacetate. An exemplary gold(I) complex that includes trifluoroacetate (TFA) as the anionic ligand is illustrated below. This gold(I) amine complex can be prepared, for example, using a silver-mediated metathesis reaction, as illustrated in the following reaction scheme:

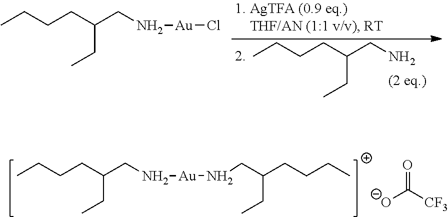

In some embodiments, the particle-free conductive ink compositions can comprise a counterion other than carboxylate. For example, gold(I) complexes can be prepared with nitrate, nitrite, tetrafluroborate, or hexafluorophosphate containing counter anions as described in the following reaction scheme:

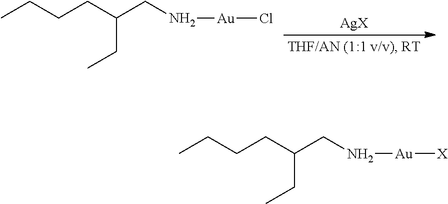

X=nitrate (NO₃⁻), nitrite (NO₂⁻), tetrafluoroborate (BF₄⁻), hexafluorophosphate (PF₆⁻)
   Particle-free conductive ink compositions comprising these alternative counterions can be prepared using any of the above-described alkylamine ligands.

The solvent of the instant conductive ink compositions can be any solvent capable of completely, or nearly completely, dissolving the gold metal complex. The solvent is also chosen for compatibility with the patterning technique to be used with the ink. In some embodiments, the solvent comprises an aromatic solvent such as anisole, toluene, or the like.

In some embodiments, the solvent comprises an alkyl or aromatic ether solvent. In more specific embodiments, the solvent comprises tetrahydrofuran or 2-methyl tetrahydrofuran.

In some embodiments, the solvent comprises an amide-type solvent, such as N,N-dimethylformamide or N,N-dimethylacetamide.

In some embodiments, the solvent can comprise an aromatic heterocyclic solvent. More specifically, the solvent can comprise a nitrogen-containing aromatic heterocyclic solvent such as, for example, a pyridine or a pyrazine. Even more specifically, the solvent can comprise pyridine or 2,5-dimethylpyrazine.

The conductive ink compositions may possess low viscosity so that they are compatible with a broad range of patterning techniques, including slot die coating, spin coating, roll-to-roll printing, including gravure, flexography, rotary screen printing, screen-printing, aerosol jet printing, inkjet printing, airbrushing, Mayer rod coating, flood coating, 3D printing, and electrohydrodynamic printing. In particular, the inks are compatible with inkjet printing, dip coating, and spray coating. The patterned features may be highly conductive at room temperature and achieve bulk conductivity upon decomposing at mild temperatures (e.g., in some cases at less than about 100° C.). Finally, the ink compositions may remain stable at room temperature for months without particle precipitation.

In preferred embodiments, the conductive ink compositions can be applied in aerosol jet applications using, for example, an Optomec Aerosol Jet 300 Series System to generate conductive features for 3D printed electronics.

Accordingly, conductive ink compositions (also referred to as “conductive inks” or “inks”) have been created for printing highly conductive features at low temperatures. Such inks may be stable, particle-free, and suitable for a wide range of patterning techniques. In some embodiments, a “particle-free” ink is one that does not include any particles at a diameter of greater than about 10 nm. In some embodiments, a “particle-free” ink is one that has less than about 1% particles, preferably less than about 0.1% particles. Gold complexes are employed in the inks as a precursor material, which ultimately yields the gold in the conductive gold coatings, lines, or patterns of the film formed in the printing process.

In some embodiments, the gold ink composition is first applied to a substrate. In some embodiments, the gold ink composition is converted to a conductive gold film structure at a temperature of about 250° C. or less. In some embodiments, the gold ink composition is converted to a conductive gold film structure at a temperature of about 100° C. or less. In some embodiments, the gold ink composition is converted to a conductive gold film structure at a temperature of about 220° C., of about 210° C. or less, of about 190° C. or less, of about 180° C. or less, of about 170° C. or less, of about 160° C. or less, of about 150° C. or less, of about 140° C. or less, of about 130° C. or less, of about 120° C. or less, of about 110° C. or less, of about 90° C. or less, of about 80° C. or less, of about 70° C. or less, of about 60° C. or less, or even of about 50° C. or less.

In some embodiments, the gold conductive ink composition has a concentration of about 1 to about 50 weight percent gold of the conductive ink composition. In some embodiments, the conductive ink composition has a concentration of about 1 to about 40 weight percent gold of the conductive ink composition. In some embodiments, the conductive ink composition has a concentration of about 1 to about 30 weight percent gold of the conductive ink composition. In some embodiments, the conductive ink composition has a concentration of about 1 to about 20 weight percent gold of the conductive ink composition. In some embodiments, the conductive ink composition has a concentration of about 1 to about 10 weight percent gold of the conductive ink composition. In some embodiments, the conductive ink composition has a concentration of about 5 to about 15 weight percent gold of the conductive ink composition. In some embodiments, the conductive ink composition has a concentration of about 1 weight percent, about 2 weight percent, about 3 weight percent, about 4 weight percent), about 5 weight percent, about 6 weight percent, about 7 weight percent, about 8 weight percent, about 9 weight percent, about 10 weight percent), about 11 weight percent), about 12 weight percent, about 13 weight percent, about 14 weight percent, about 15 weight percent, about 16 weight percent), about 17 weight percent), about 18 weight percent, about 19 weight percent, about 20 weight percent, about 21 weight percent, about 22 weight percent), about 23 weight percent, about 24 weight percent, about 25 weight percent, about 26 weight percent, about 27 weight percent, about 28 weight percent), about 29 weight percent, about 30 weight percent, about 31 weight percent, about 32 weight percent, about 33 weight percent, about 34 weight percent), about 35 weight percent, about 36 weight percent, about 37 weight percent, about 38 weight percent, about 39 weight percent, about 40 weight percent, about 41 weight percent, about 42 weight percent, about 43 weight percent, about 44 weight percent, about 45 weight percent, about 46 weight percent, about 47 weight percent, about 48 weight percent, about 49 weight percent, about 50 weight percent, or even higher weight percent gold in the conductive ink composition.

In some embodiments, the electrical conductivity of the conductive structure formed from the conductive ink composition is measured. In some embodiments, the electrical conductivity of the conductive structure is from about 2×10⁻⁶ Ohm-cm to about 1×10⁻⁵ Ohm-cm. In some embodiments, the electrical conductivity of the conductive structure is from about 3×10⁻⁶ Ohm-cm to about 6×10⁻⁶ Ohm-cm. In some embodiments, the electrical conductivity of the conductive structure is at least about 2×10⁻⁶ Ohm-cm, about 3×10⁻⁶ Ohm-cm, about 4×10⁻⁶ Ohm-cm, about 5×10⁻⁶ Ohm-cm, about 6×10⁻⁶ Ohm-cm, about 7×10⁻⁶ Ohm-cm, about 8×10⁻⁶ Ohm-cm, or about 9×10⁻⁶ Ohm-cm. In some embodiments, the electrical conductivity of the conductive structure is at most about 1×10⁻⁵ Ohm-cm, about 9×10⁻⁶ Ohm-cm, about 8×10⁻⁶ Ohm-cm, about 7×10⁻⁶ Ohm-cm, about 6×10⁻⁶ Ohm-cm, about 5×10⁻⁶ Ohm-cm, about 4×10⁻⁶ Ohm-cm, or about 3×10⁻⁶ Ohm-cm.

The electrical conductivity of the conductive structure may in some embodiments be expressed in terms of sheet resistance (i.e., bulk resistivity divided by thickness) in units of ohms per square (also referred to as ohms/square or OPS). For example, in some embodiments, the resistance of the conductive structure is no more than 5 ohms per square, no more than 2 ohms per square, no more than 1 ohm per square, no more than 0.5 ohms per square, or even lower. Preferably, the resistance of the conductive structure is no more than 1 ohm per square.

The conductive ink compositions of the instant disclosure can be used to form conductive structures having high levels of bulk gold. Specifically, in some embodiments, the conductive structure has a bulk gold content of at least 1%. In more specific embodiments, the conductive structure has a bulk gold content of at least 2%, at least 5%, at least 10%, at least 15%, at least 20%, or even higher.

### Methods for Making Conductive Ink Compositions

According to another aspect, the disclosure provides methods for making a conductive ink composition, in particular a conductive ink composition as described above. These methods comprise the step of providing a gold precursor complex, for example a reactive gold complex as described above, and dissolving the gold precursor complex in an organic solvent to form the particle-free conductive ink composition.

### Methods for Forming a Conductive Structure

In another aspect are disclosed methods of making conductive structures. In some embodiments, the methods include the step of applying the conductive ink compositions described above to a substrate. In some embodiments, the methods include the step of heating the conductive ink composition on the substrate at a decomposition temperature of about 300° C. or less to form the conductive structure. In some embodiments, the methods include the step of heating the conductive ink composition on the substrate at a decomposition temperature of about 100° C. or less to form the conductive structure. In some embodiments, the methods include the step of heating the conductive ink composition on the substrate at a decomposition temperature of about 250° C. or less, of about 200° C. or less, of about 150° C., of about 100° C. or less, or even lower temperatures, to form the conductive structure. In some embodiments, the conductive ink composition is heated with a heat source. Examples of heat sources include an IR lamp, oven, or a heated substrate.

In some embodiments, the conductive ink composition of the instant methods has a desired viscosity. In some embodiments, the desired viscosity is obtained using a micro VISC viscometer. In some embodiments, the conductive ink composition has a viscosity from about 50 centipoise to about 1000 centipoise. In some embodiments, the conductive ink composition has a viscosity from about 5 centipoise to about 50 centipoise. In some embodiments, the conductive ink composition has a viscosity from about 10 centipoise to about 40 centipoise. In some embodiments, the conductive ink composition has a viscosity from about 20 centipoise to about 30 centipoise. In some embodiments, the conductive ink composition has a viscosity from about 18 centipoise to about 20 centipoise. In some embodiments, the conductive ink composition has a viscosity of about 18, about 19, or about 20 centipoise. In some embodiments, the conductive ink composition has a viscosity of at least about 5 centipoise, about 10 centipoise, about 20 centipoise, about 30 centipoise, about 40 centipoise, about 50 centipoise, about 60 centipoise, about 70 centipoise, about 80 centipoise, about 90 centipoise, about 100 centipoise, about 200 centipoise, about 300 centipoise, about 400 centipoise, about 500 centipoise, about 600 centipoise, about 700 centipoise, about 800 centipoise, or about 900 centipoise. In some embodiments, the conductive ink composition has a viscosity of at most about 1000 centipoise, about 900 centipoise, about 800 centipoise, about 700 centipoise, about 600 centipoise, about 500 centipoise, about 400 centipoise, about 300 centipoise, about 200 centipoise, about 100 centipoise, about 90 centipoise, about 80 centipoise, about 70 centipoise, about 60 centipoise, about 50 centipoise, about 40 centipoise, about 30 centipoise, about 20 centipoise, or about 10 centipoise. Viscosities are typically measured at room temperature.

In some embodiments, the gold conductive ink composition of the instant methods has a concentration of about 0.1-50 weight percent gold complex of the ink composition. In some embodiments, the ink composition of the instant methods has a concentration of about 0.1-40 weight percent gold complex of the ink composition. In some embodiments, the ink composition has a concentration of about 1-30 weight percent gold complex of the ink composition. In some embodiments, the ink composition has a concentration of about 1-20 weight percent gold complex of the ink composition. In some embodiments, the ink composition has a concentration of about 1-10 weight percent gold complex of the ink composition. In some embodiments, the ink composition has a concentration of about 5-15 weight percent gold complex of the ink composition. In some embodiments, the ink composition has a concentration of about 0.1 weight percent, about 0.2 weight percent, about 0.3 weight percent, about 0.4 weight percent, about 0.5 weight percent, about 0.6 weight percent, about 0.7 weight percent, about 0.8 weight percent, about 0.9 weight percent, about 1 weight percent, about 2 weight percent, about 3 weight percent, about 4 weight percent, about 5 weight percent, about 6 weight percent, about 7 weight percent, about 8 weight percent, about 9 weight percent, about 10 weight percent, about 11 weight percent, about 12 weight percent, about 13 weight percent, about 14 weight percent, about 15 weight percent, about 16 weight percent, about 17 weight percent, about 18 weight percent, about 19 weight percent, or about 20 weight percent gold complex of the ink composition.

In some embodiments, the ink composition of the instant methods has a concentration of about 0.1-50 weight percent gold complex of the ink composition. In some embodiments, the ink composition of the instant methods has a concentration of about 0.1-40 weight percent gold complex of the ink composition. In some embodiments, the ink composition has a concentration of about 1-30 weight percent gold complex of the ink composition. In some embodiments, the ink composition has a concentration of about 1-20 weight percent gold complex of the ink composition. In some embodiments, the ink composition has a concentration of about 1-10 weight percent gold complex of the ink composition. In some embodiments, the ink composition has a concentration of about 5-15 weight percent gold complex of the ink composition.

In some embodiments, the electrical conductivity of the conductive structures is measured. In some embodiments, the electrical conductivity of the conductive structures is about 1×10⁻⁶ Ohm-cm or greater. In some embodiments, the electrical conductivity of the conductive structures is from about 1×10⁻⁶ Ohm-cm to about 8×10⁻⁴ Ohm-cm. In some embodiments, the electrical conductivity of the conductive structures is from about 3×10⁻⁶ Ohm-cm to about 6×10⁻⁶ Ohm-cm. In some embodiments, the electrical conductivity of the conductive structures is at least about 1×10⁻⁶ Ohm-cm, about 2×10⁻⁶ Ohm-cm, about 3×10⁻⁶ Ohm-cm, about 4×10⁻⁶ Ohm-cm, about 5×10⁻⁶ Ohm-cm, about 6×10⁻⁶ Ohm-cm, about 7×10⁻⁶ Ohm-cm, about 8×10⁻⁶ Ohm-cm, about 9×10⁻⁶ Ohm-cm, about 1×10⁻⁵ Ohm-cm, about 2×10⁻⁵ Ohm-cm, about 3×10⁻⁵ Ohm-cm, about 4×10⁻⁵ Ohm-cm, about 5×10⁻⁵ Ohm-cm, about 6×10⁻⁵ Ohm-cm, about 7×10⁻⁵ Ohm-cm, about 8×10⁻⁵ Ohm-cm, about 9×10⁻⁵ Ohm-cm, about 1×10⁻⁴ Ohm-cm, about 2×10⁻⁴ Ohm-cm, about 3×10⁻⁴ Ohm-cm, about 4×10⁻⁴ Ohm-cm, about 5×10⁻⁴ Ohm-cm, about 6×10⁻⁴ Ohm-cm, or about 7×10⁻⁴ Ohm-cm. In some embodiments, the electrical conductivity of the conductive structures is at most about 8×10⁻⁴ Ohm-cm, 7×10⁻⁴ Ohm-cm, about 6×10⁻⁴ Ohm-cm, about 5×10⁻⁴ Ohm-cm, about 4×10⁻⁴ Ohm-cm, about 3×10⁻⁴ Ohm-cm, about 2×10⁻⁴ Ohm-cm, or about 1×10⁻⁴ Ohm-cm, about 9×10⁻⁵ Ohm-cm, about 8×10⁻⁵ Ohm-cm, about 7×10⁻⁵ Ohm-cm, about 6×10⁻⁵ Ohm-cm, about 5×10⁻⁵ Ohm-cm, about 4×10⁻⁵ Ohm-cm, about 3×10⁻⁵ Ohm-cm, about 2×10⁻⁵ Ohm-cm, about 1×10⁻⁵ Ohm-cm, about 9×10⁻⁶ Ohm-cm, about 8×10⁻⁶ Ohm-cm, about 7×10⁻⁶ Ohm-cm, about 6×10⁻⁶ Ohm-cm, about 5×10⁻⁶ Ohm-cm, about 4×10⁻⁶ Ohm-cm, about 3×10⁻⁶ Ohm-cm, or about 2×10⁻⁶ Ohm-cm.

### Applications of the Ink Compositions

The ink compositions of the instant disclosure can be used in various printing applications, including slot die coating, spin coating, roll-to-roll printing, including gravure, flexography, rotary screen printing, screen printing, aerosol jet printing, inkjet printing, airbrushing, Mayer rod coating, flood coating, 3D printing, and electrohydrodynamic painting. In particular, the inks can be used in inkjet printing, dip coating, and spray coating. Furthermore, patterns can be created using photolithography to create a mask to etch the gold from certain areas, thereby creating high-fidelity features.

In preferred embodiments, the ink compositions are used in aerosol jet printing applications to print conductive structures comprising gold metal. This method, which is also known as maskless mesoscale materials deposition or M3D (see, e.g., U.S. Pat. No. 7,485,345), involves atomization of the particle-free ink composition, via ultrasonic or pneumatic techniques, to generate droplets of micrometer scale. The aerosolized ink is combined with a carrier gas and directed via a flowhead onto a substrate where the ink is ultimately cured to a conductive structure.

In some embodiments, the ink compositions are compatible with many nonpolar polymer substrates, glasses, and ceramic substrates where polar complexes do not wet particularly well. In some embodiments, the ink composition is applied to a polymer substrate. In some embodiments, the ink composition is applied to a nonpolar polymer substrate. In some embodiments, the ink composition is applied to a glass substrate. In some embodiments, the ink composition is applied to a ceramic substrate.

Furthermore, elastomers and 3D substrates with specifically non-planar topography can be used in conjunction with the conductive structures. In some embodiments, the ink composition is applied to an elastomer. In some embodiments, the ink composition is applied to a 3D substrate.

It will be readily apparent to one of ordinary skill in the relevant arts that other suitable modifications and adaptations to the compositions and methods described herein may be made without departing from the scope of the invention or any embodiment thereof. Having now described the present invention in detail, the same will be more clearly understood by reference to the following Examples, which are included herewith for purposes of illustration only and are not intended to be limiting of the invention.

### EXAMPLES

### Synthesis of (chloro)(2-ethyl-1-hexylamine)gold(I)

Into a 250 mL reaction flask was added chloro(tetrahydrothiophene) gold(I) (10 g) under nitrogen atmosphere. To this was added 120 mL dry dichloromethane followed by 18 mL dry acetonitrile. The reaction mixture was stirred for 5 minutes followed by the addition of 2-ethyl-1-hexylamine (5.11 mL). The reaction mixture was left stirring at room temperature under the exclusion of light for about 12 hours. After this time period, the volatiles were removed through rotary evaporation to render a white fluffy solid crude product. To this was added 10 mL of dry pentane to form a slurry of product. The product was finally filtered using a glass-fritted funnel and washed with 10 mL pentane (2×). The white product obtained was collected and dried under high vacuum for 16 hours. Yield: 90%. 1H NMR (CDCl₃, 400 MHZ, ppm) δ 4.67 (s), 4.41 (s), 2.95-2.98 (m), 2.60-2.61 (m), 1.61-1.65 (m), 1.27-1.43 (m), 0.87-0.92 (m).

### Synthesis of (trifluoroacetato)(2-ethyl-1-hexylamine)gold(I)

A 500 mL oven-dried reaction flask was loaded with a stir bar and (chloro)(2-ethyl-1-hexylamine)gold(I) (5 g). The atmosphere of the flask was replaced with nitrogen by three vacuum and refill nitrogen cycles using the Schlenk line. Into the reaction flask was added 140 mL anhydrous tetrahydrofuran through a syringe. In a separate reaction flask silver trifluoroacetate (2.244 g, 0.9 eq) was dissolved in 114 mL of anhydrous acetonitrile. The solution was then injected into the previous reaction mixture at once. Immediate formation of white precipitate was observed. The reaction was stirred for 1 hour and filtered using 0.22 um PTFE filter. The clear filtrate was collected. The volatiles were removed using a rotary evaporator. A thick liquid was obtained, which was further dried using Schlenk line for 2-3 hours under the exclusion of light to obtain a thick gel-like consistency. Yield: 72%. ¹H NMR (CDCl₃, 400 MHz, ppm) § 4.95 (s), 2.86-2.88 (m), 2.63-2.64 (m), 1.72 (s), 1.72 (m), 1.27-1.44 (m), 0.86-0.92 (m). 19F NMR (CDCl₃, 400 MHz, ppm) 8-75.10 (s).

### Exemplary Ink Formulation with (chloro)(2-ethyl-1-hexylamine)gold(I) Precursor and their Curing Profile

Formulation 1:0.200 g (20 wt %) of (chloro)(2-ethyl-1-hexylamine)gold(I) was dissolved in 0.800 g (80 wt %) toluene. The solution was stirred for 10 minutes. After filtering through 0.22 um filter, a clear transparent solution was obtained with a viscosity of 1.2 centipoise and 4.5 wt % solid content.

The ink was printed using Optomec's aerosol jet printer with the ultrasonication atomization attachment on a platen from 25° C. with increasing passes from one to three layers. Regular wire and pads were printed on glass substrates for multiple hours without clogging or any change in ink appearance. With optimized printing conditions, solid lines were printed without any ink runniness or overflowing. The film starts curing from 150° C. and lustrous gold color was visible. However, higher conductivity is obtained when they are further cured at elevated temperatures. The printed wire-pad structures were annealed at 240° C. for 30 minutes and an additional 30 minutes at 300° C. Conductivity obtained after curing at 300° C. is 21% bulk gold.

### Exemplary Ink Formulations with (trifluoroacetato)(2-ethyl-1-hexylamine)gold(I) And their Curing Profiles

Formulation 2:1.000 g (20 wt %) of (trifluoroacetato)(2-ethyl-1-hexylamine)gold(I) was dissolved in 4.000 g (80 wt %) of toluene. The solution was stirred for 10 minutes. After complete precursor dissolution, a clear transparent solution was obtained with a viscosity of 0.8 centipoise and 3.9% solid content.

The ink was printed using an Optomec aerosol jet printer with the ultrasonic atomization attachment on a platen from 25° C. with increasing passes from one to three layers. Regular wires and pads were printed on glass substrates for multiple hours without clogging or any change in ink appearance. With optimized printing conditions, solid lines were printed without any ink runniness or overflowing. The film starts curing from 150° C. and lustrous gold color was visible. Higher conductivity is obtained when the printed samples were further cured at elevated temperatures. The printed wire-pad structures were annealed on hotplate by ramping from 25° C. to 300° C. for 5 minutes and an additional 30 minutes at 300° C. Conductivity obtained after curing at 300° C. was 43% bulk gold.

Formulation 3:0.600 g (40 wt %) of (trifluoroacetato)(2-ethyl-1-hexylamine)gold(I) was dissolved in 0.900 g (60 wt %) of anisole. The solution was stirred for 10 minutes. After complete precursor dissolution, a clear transparent solution was obtained with a viscosity of 1.9 centipoise and 9.3% solid content.

The ink was printed using an Optomec aerosol jet printer with the ultrasonic atomization attachment on a platen from 25° C. with increasing passes from one to three layers. Regular wires and pads were printed on glass substrates for multiple hours without clogging or any change in ink appearance. With optimized printing conditions, solid lines were printed without any ink runniness or overflowing. The film starts curing from 150° C. and lustrous gold color was visible. Higher conductivity was obtained when the printed samples were further cured at elevated temperatures. The printed wire-pad structures were annealed on a hotplate by ramping from 25° C. to 300° C. for 5 minutes and an additional 30 minutes at 300° C. Conductivity obtained after curing at 300° C. was 21% bulk gold.

### Exemplary Ink Formulation with 2-amino-5-methylhexane gold chloride And its Curing Profile

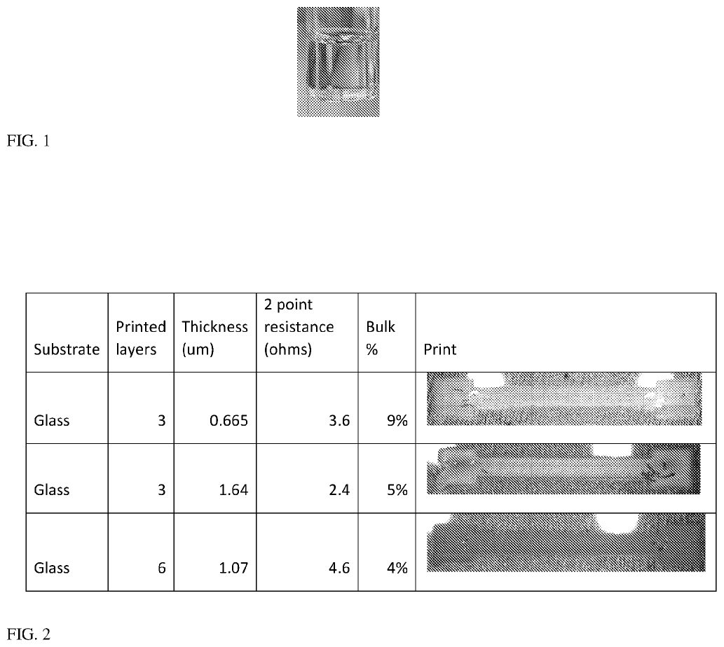

Formulation 4:2-amino-5-methylhexane gold chloride (10%) was dissolved in pyridine (90%) to form a clear liquid with a solid content of 4%, as shown in FIG. 1.

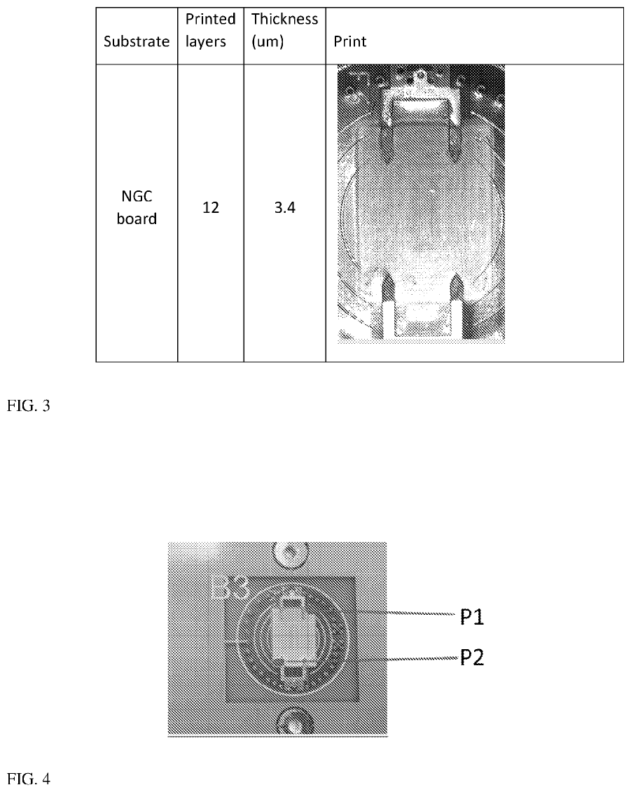

Various layers of the ink formulation were printed either on a glass substrate (FIG. 2) or a circuit board substrate (FIG. 3). After curing, the gold structure formed from the ink had the physical, electrical, and structural properties shown in FIGS. 2 and 3. The two-point resistance between “P1” and “P2” in the printed structure shown in FIG. 4 was 9 ohms.

All patents, patent publications, and other published references mentioned herein are hereby incorporated by reference in their entireties as if each had been individually and specifically incorporated by reference herein.

While specific examples have been provided, the above description is illustrative and not restrictive. Any one or more of the features of the previously described embodiments can be combined in any manner with one or more features of any other embodiments in the present invention. Furthermore, many variations of the invention will become apparent to those skilled in the art upon review of the specification. The scope of the invention should, therefore, be determined by reference to the appended claims, along with their full scope of equivalents.

What is claimed is:

1. A particle-free conductive ink composition comprising:
a gold metal;
an alkylamine ligand; and
a solvent;
wherein the particle-free conductive ink composition forms a conductive metallic film by curing at an elevated temperature.

2. The particle-free conductive ink composition of claim 1, wherein the gold metal is a gold(I) metal ion.

3. The particle-free conductive ink composition of claim 1, wherein the alkylamine ligand is volatile at a temperature of no more than about 200° C.

4. The particle-free conductive ink composition of claim 1, wherein the alkylamine ligand is a C₃-C₁₂ alkylamine ligand.

5. The particle-free conductive ink composition of claim 1, wherein the alkylamine ligand is a branched alkylamine ligand.

6. The particle-free conductive ink composition of claim 1, wherein the alkylamine ligand is a primary alkylamine ligand.

7. The particle-free conductive ink composition of claim 1, wherein the alkylamine ligand is an alkyl-substituted hexylamine.

8. The particle-free conductive ink composition of claim 7, wherein the alkyl-substituted hexylamine is a methyl- or ethyl-substituted hexylamine.

9. The particle-free conductive ink composition of claim 8, wherein the alkyl-substituted hexylamine is 2-ethyl-1-hexylamine or 2-amino-5-methylhexane.

10. The particle-free conductive ink composition of claim 1, wherein the alkylamine ligand is a di-chelated primary, secondary, or tertiary alkyl diamine compound.

11. The particle-free conductive ink composition of claim 10, wherein the alkylamine ligand has a structure of formula (I): 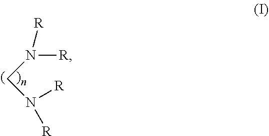
wherein each R is independently hydrogen or a C₁-C₁₄ alkyl group, and n is 1-14.

12. The particle-free conductive ink composition of claim 11, wherein each R group is independently hydrogen or a C₁-C₄ alkyl group, and each n is independently from 1 to 10.

13. The particle-free conductive ink composition of claim 1, wherein the alkylamine ligand is a C₂-C₁₂ alkylamine ligand substituted with at least one heteroatom.

14. The particle-free conductive ink composition of claim 13, wherein the at least one heteroatom is at least one oxygen or sulfur.

15. The particle-free conductive ink composition of claim 1, wherein the alkylamine ligand is a C₄-C₁₀ 2-amino-alkyl compound.

16. The particle-free conductive ink composition of claim 1, wherein the solvent comprises an aromatic solvent.

17. The particle-free conductive ink composition of claim 1, wherein the solvent comprises an alkyl or aromatic ether solvent.

18. The particle-free conductive ink composition of claim 1, wherein the solvent comprises tetrahydrofuran or 2-methyl tetrahydrofuran.

19. The particle-free conductive ink composition of claim 1, wherein the solvent comprises an amide-type solvent.

20. The particle-free conductive ink composition of claim 1, wherein the solvent comprises an aromatic heterocyclic solvent.

21. The particle-free conductive ink composition of claim 20, wherein the aromatic heterocyclic solvent comprises a pyridine or a pyrazine.

22. The particle-free conductive ink composition of claim 21, wherein the aromatic heterocyclic solvent comprises pyridine or 2,5-dimethylpyrazine.

23. The particle-free conductive ink composition of claim 1, further comprising a counterion.

24. The particle-free conductive ink composition of claim 23, wherein the counterion is a carboxylate.

25. The particle-free conductive ink composition of claim 24, wherein the particle-free conductive ink composition releases carbon dioxide upon heating.

26. The particle-free conductive ink composition of claim 25, wherein the particle-free conductive ink composition releases carbon dioxide upon heating at no more than about 300° C.

27. The particle-free conductive ink composition of claim 23, wherein the counterion is a haloacetate.

28. The particle-free conductive ink composition of claim 27, wherein the haloacetate is trifluoroacetate.

29. The particle-free conductive ink composition of claim 23, wherein the counterion is nitrate, nitrite, tetrafluroborate, or hexafluorophosphate.

30. The particle-free conductive ink composition of claim 1, wherein the particle-free conductive ink composition forms a conductive metallic film by curing at no more than 300° C.

31. The particle-free conductive ink composition of claim 1, wherein the conductive metallic film displays a conductivity of at least 1% bulk metal conductivity.

32. A method of forming a conductive film comprising the steps of:
providing the particle-free conductive ink composition of any one of claims 1-31;
applying the composition to a substrate; and
curing the composition at an elevated temperature to form the conductive film.

33. The method of claim 32, wherein the applying step comprises a printing step.

34. The method of claim 33, wherein the printing step is a jet printing step.

35. The method of claim 34, wherein the jet printing step is an aerosol jet printing step.

36. The method of claim 32, wherein the composition is cured at no more than 300° C.

37. A conductive film formed by applying the particle-free conductive ink composition of any one of claims 1-31 to a substrate and curing the composition at an elevated temperature to form the conductive film.

38. The conductive film of claim 37, wherein the curing is at no more than 300° C.

39. A method of preparing a particle-free conductive ink composition comprising the steps of:
providing an alkylamine-gold complex; and
dissolving the alkylamine-gold complex in a solvent to form the particle-free conductive ink composition;
wherein the alkylamine-gold complex comprises a gold metal and an alkylamine ligand; and
wherein the particle-free conductive ink composition forms a conductive metallic film by curing at an elevated temperature.

40. The method of claim 39, wherein the gold metal is a gold(I) metal ion.

41. The method of claim 39, wherein the alkylamine ligand is volatile at a temperature of no more than about 200° C.

42. The method of claim 39, wherein the alkylamine ligand is a C₃-C₁₂ alkylamine.

43. The method of claim 39, wherein the alkylamine ligand is a branched alkylamine.

44. The method of claim 39, wherein the alkylamine ligand is a primary alkylamine.

45. The method of claim 39, wherein the alkylamine ligand is an alkyl-substituted hexylamine.

46. The method of claim 45, wherein the alkyl-substituted hexylamine is a methyl- or ethyl-substituted hexylamine.

47. The method of claim 46, wherein the alkyl-substituted hexylamine is 2-ethyl-1-hexylamine or 2-amino-5-methylhexane.

48. The method of claim 39, wherein the alkylamine ligand is a di-chelated primary, secondary, or tertiary alkyl diamine compound.

49. The method of claim 48, wherein the alkylamine ligand has a structure of formula (I): 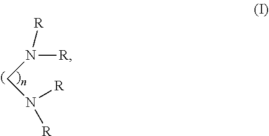
wherein each R is independently hydrogen or a C₁-C₁₄ alkyl group, and n is 1-14.

50. The method of claim 49, wherein each R group is independently hydrogen or a C₁-C₄ alkyl group, and each n is independently from 1 to 10.

51. The method of claim 39, wherein the alkylamine ligand is a C₂-C₁₂ alkylamine ligand substituted with at least one heteroatom.

52. The method of claim 51, wherein the at least one heteroatom is at least one oxygen or sulfur.

53. The method of claim 39, wherein the alkylamine ligand is a C₄-C₁₀ 2-amino-alkyl compound.

54. The method of claim 39, wherein the solvent comprises an aromatic solvent.

55. The method of claim 39, wherein the solvent comprises an alkyl or aromatic ether solvent.

56. The method of claim 39, wherein the solvent comprises tetrahydrofuran or 2-methyl tetrahydrofuran.

57. The method of claim 39, wherein the solvent comprises an amide-type solvent.

58. The method of claim 39, wherein the solvent comprises an aromatic heterocyclic solvent.

59. The method of claim 58, wherein the aromatic heterocyclic solvent comprises a pyridine or a pyrazine.

60. The method of claim 59, wherein the aromatic heterocyclic solvent comprises pyridine or 2,5-dimethylpyrazine.

61. The method of claim 39, wherein the particle-free conductive ink composition further comprises a counterion.

62. The method of claim 61, wherein the counterion is a carboxylate.

63. The method of claim 62, wherein the particle-free conductive ink composition releases carbon dioxide upon heating.

64. The method of claim 63, wherein the particle-free conductive ink composition releases carbon dioxide upon heating at no more than about 300° C.

65. The method of claim 61, wherein the counterion is a haloacetate.

66. The method of claim 65, wherein the haloacetate is trifluoroacetate.

67. The method of claim 61, wherein the counterion is nitrate, nitrite, tetrafluroborate, or hexafluorophosphate.
